(19) United States
(12) Patent Application Publication
(10) Pub. No.: US 2007/0061101 A1
(43) Pub. Date: Mar. 15, 2007

(54) Input device for providing position information to information handling systems

(75) Inventors: David Perry Greene, Austin, TX (US); Barry L. Minor, Austin, TX (US); Blake Andrew Robertson, Reisterstown, MD (US); VanDung Dang To, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/225,569

(22) Filed: Sep. 13, 2005

(51) Int. Cl. G01C 17/00

(52) U.S. Cl. 702/152

(57) ABSTRACT

An input device is disclosed, one embodiment of which provides position information to an information handling system (IHS). The position information includes both location information and spatial orientation information of the input device in real space. The input device includes a location sensor which determines the absolute location of the input device in x, y and z coordinates. The input device also includes a spatial orientation sensor that determines the spatial orientation of the input device in terms of yaw, pitch and roll. The input device further includes a processor that processes the location information and the spatial orientation information of the input device in real space to determine an image view from the perspective of the input device in virtual space. Movement of the input device in real space by a user causes a corresponding movement of an image view from the perspective of the input device in virtual space. The input device itself displays the image view, or alternatively, an IHS to which the input device couples displays the image view.

### TECHNICAL FIELD OF THE INVENTION

The disclosures herein relate generally to input devices, and more particularly, to input devices for information handling systems (IHSs).

### BACKGROUND

Information handling systems (IHSs) process, transfer, manipulate, communicate, compile, store or otherwise handle information. IHSs include, but are not limited to, mainframes, minicomputers, microcomputers, nanocomputers, desktop computers, portable computers, laptop computers, notebook computers, personal digital assistants (PDAs), servers, networked systems, telephone devices, communication devices, and microcontroller systems.

An input device typically couples to an IHS to provide input information thereto. Many different types of input devices can provide position information to IHSs. For example, the conventional computer mouse that moves laterally on a flat surface can provide position information in two dimensions, namely the x and y axes. A tablet input device also provides x and y coordinate information to the IHS when a user moves a stylus in the x and y plane of the tablet. Joystick input devices also provide position information to IHSs. For example, a typical analog joystick input device provides pitch information when the user moves the joystick from front to back and from back to front. The analog joystick input device also provides yaw information when moved from side to side, i.e. from left to right and from right to left. Game controller input devices are known that include four buttons arranged so that the user can move a cursor on a display from left to right, from right to left, or backward and forward somewhat like a joystick.

The mouse, tablet and joystick discussed above are examples of input devices that employ an actuated control mode because these devices transfer the position of an actuator (e.g. joystick, stylus/tablet) into a corresponding effect in virtual space. Input devices are also available that employ a direct (kinematic) control mode. In direct control mode input devices, the position in virtual space is a direct function of the position coordinates of the input device itself in real space. A virtual glove is one example of a direct control mode input device. When a user wears a virtual glove input device, movement of the virtual glove by the user in real space causes movement of a locus in virtual space. Unfortunately, the user may have difficulty moving the virtual glove into some locations, for example under an object such as a chair or other difficult to reach location. The user may experience further difficulty in moving the virtual glove to some locations because the virtual glove may be tethered to a computer which limits motion of the virtual glove.

What is needed is a method and apparatus that addresses the problems discussed above.

### SUMMARY

Accordingly, in one embodiment, a method is disclosed for operating an input device to provide position information that includes both location information and spatial orientation information of the input device. The method includes determining, by a location sensor in the input device, the absolute location of the input device in real space, thus providing the location information. The method also includes determining, by a spatial orientation sensor in the input device, the spatial orientation of the input device in real space, thus providing the spatial orientation information. The method further includes processing, by a processor, the location information and the spatial orientation information of the input device in real space to determine an image view from the perspective of the input device in virtual space. In one embodiment, the input device provides location information which defines the location of the input device in an x, y, z coordinate system. In another embodiment, the input device provides spatial orientation information that defines the spatial orientation of the input device in terms of yaw, pitch and roll.

In another embodiment, an input device is disclosed that provides position information including location information and spatial orientation information of the input device. The input device includes a location sensor that determines the absolute location of the input device in real space to provide the location information. The input device also includes a spatial orientation sensor that determines the spatial orientation of the input device in real space to provide the spatial orientation information. The input device further includes a processor, coupled to the location sensor and the spatial orientation sensor, that processes the location information and the spatial orientation information of the input device in real space to determine an image view from the perspective of the input device in a virtual space.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows block diagram of one embodiment of the disclosed input device.

FIG. 2 shows a representative input device relative to axes x, y and z.

FIG. 3 shows an alternative embodiment of the disclosed input device wherein the input device itself is configured as an information handling system.

FIG. 4 shows an alternative embodiment of the input device of FIG. 3.

FIG. 5 shows a representative mechanical layout of the input device of FIG. 4.

FIG. 6 shows a flowchart that describes process flow of the application software loaded into the memory of an information handling system type of input device.

### DETAILED DESCRIPTION

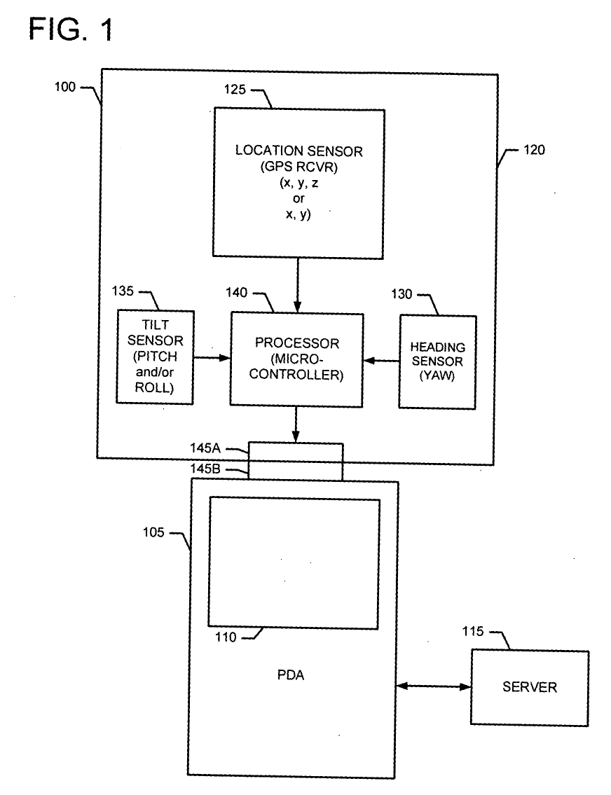

FIG. 1 shows an input device 100 coupled to a display device 105 such as a personal digital assistant (PDA), video terminal or other video display. Display device 105 includes a display screen or panel 110 which displays an image related to real time position information provided thereto by input device 100. The position information includes location information, namely the current absolute position of input device 100 as defined by the x, y and z coordinates of input device 100. The position information also includes spatial orientation information, namely the current yaw, pitch and roll of input device 100, in one embodiment. When a user moves input device 100 in real space, the position information provided by input device 100 to display device 105 changes to enable display device 105 to display an image in virtual space as though the user were viewing a scene from the location and spatial orientation of input device 100 as specified by the position information. In one embodiment, the position information provided by input device 100 changes in real time as the user moves input device 100.

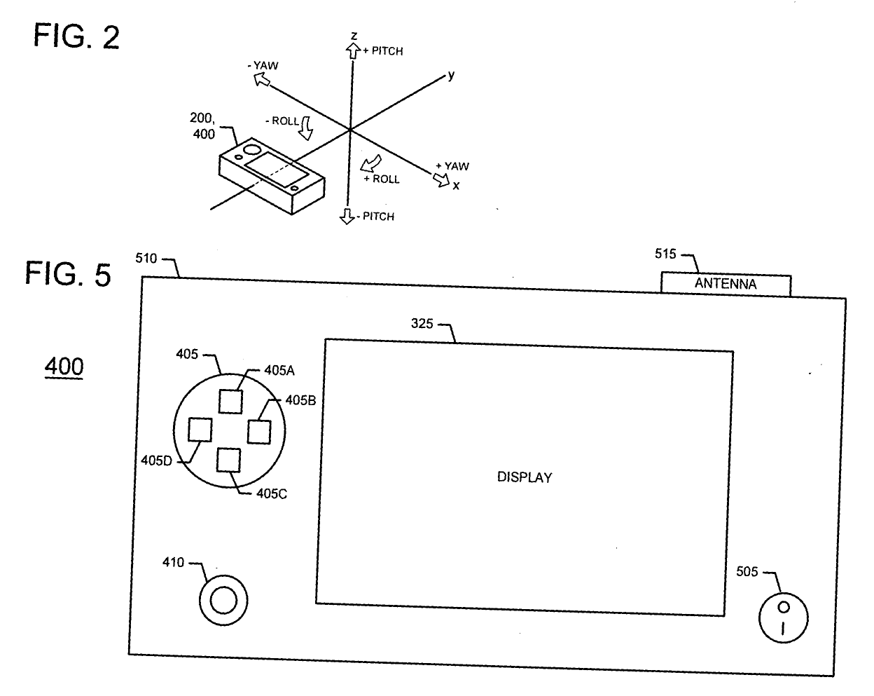

In one embodiment display device 105 couples to a server system 115 so that server system 115 can augment the local image processing abilities of display device 105 to display the view specified by the position information it receives from input device 100. More particularly, connector 145 couples a processor 140 of input device 100 to display device 105. Connector portion 145A of input device 100 mates with connector portion 145B of display device 105 to achieve this coupling. Server system 115 receives the position information that display device 105 receives from input device 100. Server system 1 15 renders or manipulates the real time position information into image information representative of the real time view seen be a hypothetical observer located on input device 100. Server system 115 supplies the image information to display device 100 for viewing by the user. Other embodiments are possible wherein display device 105 includes a processor having sufficient computational power to perform image processing or image rendering locally rather than offloading that function to server system 115. Yet another embodiment is possible wherein input device 100 includes sufficient computational processing power to perform the above described image processing as will be discussed below in more detail with reference to FIG. 2.

Input device 100 includes a printed circuit board 120 which couples a location sensor 125, a heading sensor 130, and a tilt sensor device 135 to a processor 140. In this particular embodiment, input device 100 employs a Model PIC16F628 microcontroller made by Microchip Technology Inc. as processor 140, although input device 100 may employ other microcontrollers and processors as well. Processor 140 mounts on printed circuit board 120 as shown. Location sensor 125, such as a Global Positioning System (GPS) receiver, determines the x, y and z location coordinates of input device 100 and provides this location information to processor 140. GPS receiver 125 thus keeps processor 140 informed of the current absolute position of input device 100 in real time. In one embodiment, GPS receiver determines the x and y coordinates and ignores the z coordinate. In such an embodiment, input device 100 can ignore the z value and assume that input device 100 is located at a fixed height, z, above the xy plane. In other words, in this simplified embodiment, GPS receiver 125 provides the absolute location information of input device 100 relative to the xy plane as defined in FIG. 2. The Model i360 GPS receiver manufactured by Pharos Science and Applications, Inc. produces acceptable results when employed as location sensor 125.

Heading sensor 130 determines the current absolute heading or direction of input device 100 in real time. In other words, heading sensor 130 determines the direction that input device 100 currently points in real time. Heading sensor 130 provides absolute heading information to processor 140 in one embodiment. The Model HMC6352 digital compass manufactured by Honeywell produces acceptable results when employed as digital compass 130.

Tilt sensor 135 determines the pitch and roll of input device 100 in real time. In other words, tilt sensor 135 determines when the user pitches input device up and down. Tilt sensor 135 also determines when the user rolls input device clockwise to the right or counter clockwise to the left. Tilt sensor 135 provides pitch information and roll information to processor 140 in real time. Pitch information and roll information are types of spatial orientation information. The Model ADXL202E accelerometer manufactured by Analog Device, Inc. produces acceptable results when employed as tilt sensor 135. This particular accelerometer is a dual axis accelerometer. Input device 100 employs one axis of dual axis tilt sensor 135 to measure positive and negative pitch. Positive and negative pitches define one type of tilt exhibited by input device 100 when the user tilts input device 100 upward and downward. Input device 100 employs the remaining axis of dual axis tilt sensor 135 to measure roll. Input device 100 exhibits another type of tilt, namely roll, when the user tilts input device 100 clockwise or counter clockwise. In one embodiment, input device 100 ignores the roll information that tilt sensor 135 provides.

FIG. 2 shows a representative input device 200 relative to axes x, y and z. Input device 200 includes many elements in common with input device 100;

however, input device 200 integrates many of these elements in a common housing.

FIG. 2 includes appropriate arrows to indicate pitch, yaw and roll. Pitch defines rotational motion about the x axis. Yaw defines rotational motion about the z axis;

and roll defines rotational motion about the y axis. When the user moves input device 200 in the x-y plane, GPS receiver 125 determines the coordinates of input device 200 in the x-y plane. In one embodiment, GPS receiver 200 also provides z axis information with respect to input device 200. In this manner, GPS receiver 125 provides the absolute position of input device 200 to processor 140. When the user rotates input device 200 to the right in the xy plane, heading sensor 130 detects this as positive yaw. When the user rotates input device to the left in the xy plane, heading sensor 130 detects this as negative yaw. However, when the user rotates or tilts input device 200 upward in the yz plane, tilt sensor 135 detects this as positive pitch. Conversely, if the user rotates or tilts input device downward in the yz plane, tilt sensor 135 detects this as negative pitch. When the user rotates input device 200 about the y axis in a clockwise direction, tilt sensor 135 detects this as positive roll. However, when the user rotates input device 200 about the y axis in a counter clockwise direction, tilt sensor 135 detects this action as a negative roll. Processor 140 receives all of this position information, namely the x, y, z location information and the yaw, pitch and roll spatial orientation information as a serial data stream. Display device 105 displays an image in virtual space that corresponds to the location and spatial orientation of input device 200 in real space.

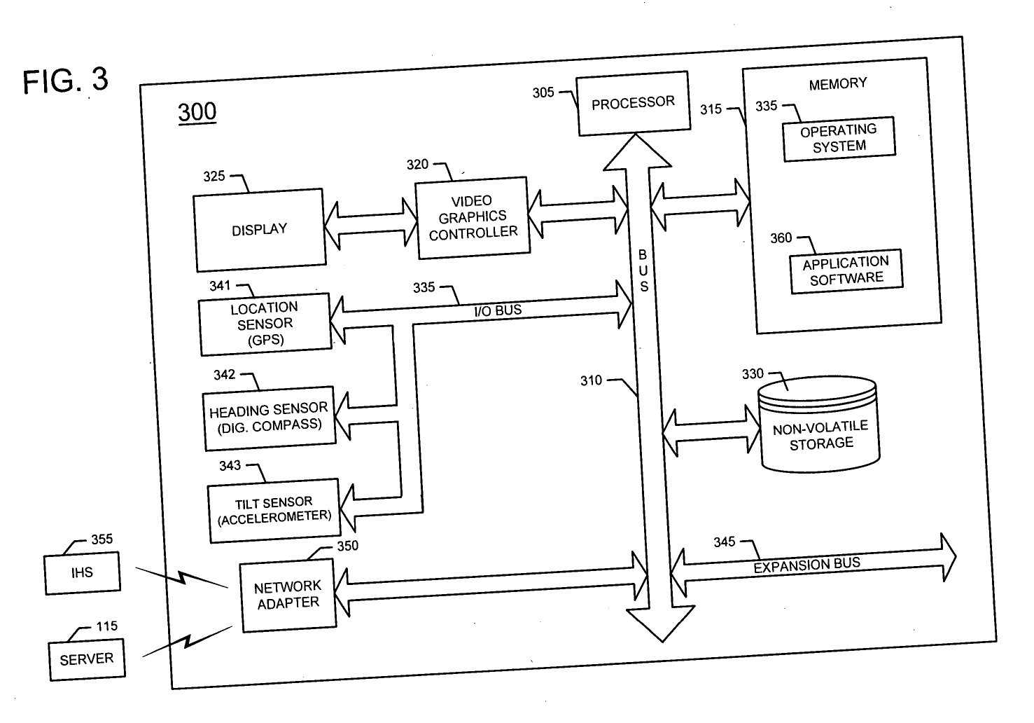

As seen in FIG. 3, the disclosed input device can itself be configured as an information handling system (IHS) type of input device 300. In this embodiment, input device 300 is configured as an information handling system that can provide input, namely position information, to another information handling system 355. Input device 300 includes a processor 305. Bus 310 couples processor 305 to system memory 315 and video graphics controller 320. A display 325 couples to video graphics controller 320. Nonvolatile storage 330, such as a hard disk drive, CD drive, DVD drive, or other nonvolatile storage couples to bus 310 to provide IHS input device 300 with permanent storage of information. An operating system 335 loads in memory 315 to govern the operation of IHS input device 300. An I/O bus 335, such as a Universal Serial Bus (USB), for example, couples to bus 310 to connect I/O devices such as sensors 341, 342, and 343 to processor 305. More particularly, location sensor 341, such as a GPS receiver, couples to I/O bus 335 to provide processor 305 with location information to processor 305. This location information includes the x, y and z location information of IHS input device 300 in real space. In other words, in one embodiment, location sensor 341 communicates the absolute position of IHS input device 300 to processor 305. Heading sensor 342, such as a digital compass, couples to I/O bus 335 to provide processor 305 with the absolute heading or yaw of IHS input device 300. Tilt sensor 343, such as an accelerometer device, couples to I/O bus 335 to provide processor 305 with pitch and roll information. Tilt sensor 343 thus helps define the spatial orientation of IHS input device 300. Heading sensor 342 and tilt sensor 343 together form a spatial orientation sensor. In other embodiments, other I/O devices such as a keyboard and a mouse pointing device may be coupled to I/O bus 335 depending on the particular application. One or more expansion busses 345, such as an IEEE 1394 bus, ATA, SATA, PCI, PCIE and other busses, couple to bus 310 to facilitate the connection of peripherals and devices to IHS input device 300. A network adapter 350 couples to bus 310 to enable IHS input device 300 to connect by wire or wirelessly to server 115 to enable processor 305 to offload graphics rendering as needed to server 115. The graphics rendering that input device 300 may offload to server 115 includes rendering in virtual space the view as seen from the location and spatial orientation of input device 300 as sensed in real space by input device 300. Input device 300 displays the rendered image on display 325. However, if IHS input device 300 exhibits sufficient on-board processing power to render the image, then input device 300 need not offload image rendering tasks to server 115.

In one embodiment, input device 300 couples by wire or wirelessly to an external IHS 355. In such a configuration, device 300 acts as a location and spatial orientation sensing device for IHS 355. IHS 355 includes a display (not shown) that displays the rendered image received form input device 300.

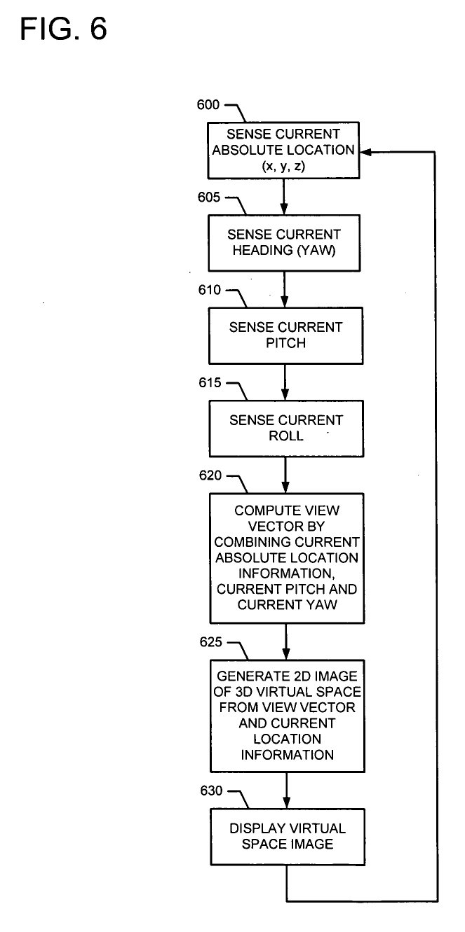

IHS input device 300 loads application software 360 from nonvolatile storage 330 to memory 315 for execution. The particular application software 360 loaded into memory 315 of IHS input device 300 determines the operational characteristics of input device 300. In one embodiment, application software 360 controls the processing of the location and spatial orientation information that input device 300 receives from location sensor 341, heading sensor 342 and tilt sensor 343 as discussed in more detail below with reference to the flowchart of FIG. 6. At a high level, application software 360 programs IHS input device 300 to render an image in virtual space that represents the view corresponding to the location and spatial orientation of input device 300 in real space.

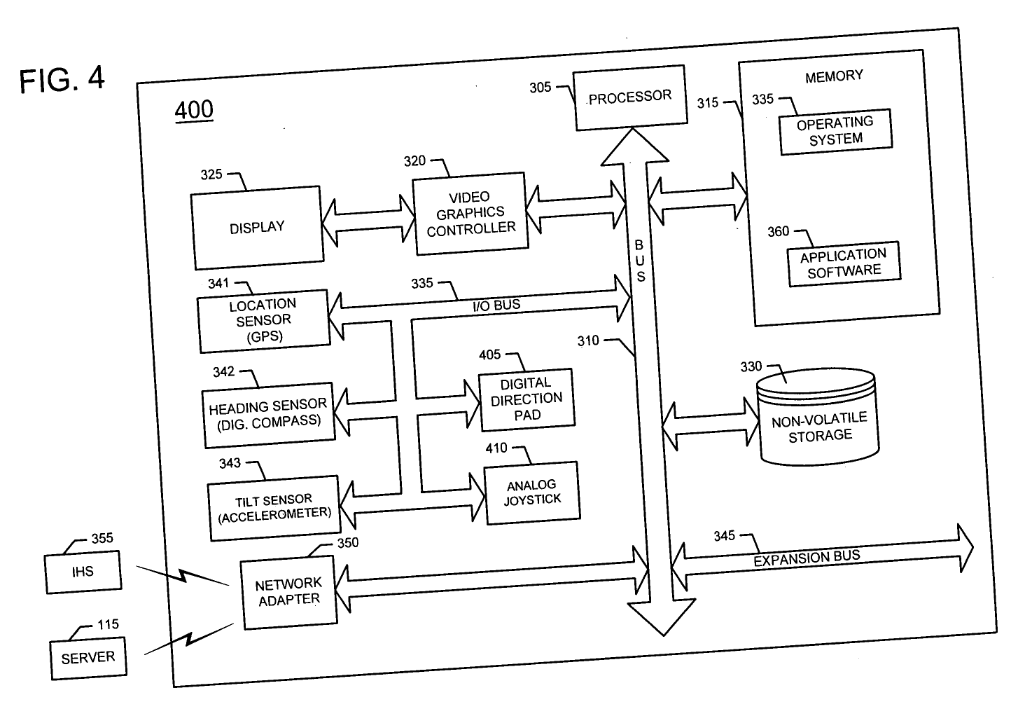

FIG. 4 shows another embodiment of the IHS input device as IHS input device 400. Input device 400 of FIG. 4 includes many elements in common with input device 300 of FIG. 3. Like numbers indicate like elements when comparing FIG. 4 with FIG. 3. In addition to sensors 341, 342 and 343, input device 400 includes a digital direction pad 405. In one embodiment, digital pad 405 includes 4 direction buttons 405A, 405B, 405C and 405D as seen in the mechanical representation of input device 400 depicted in FIG. 5. Each of buttons 405A, 405B, 405C and 405D corresponds to a different orthogonal direction, respectively. By pressing these buttons, the user can move a cursor or object on display 325 up and down and/or right and left in a fashion similar to a computer game controller. IHS input device 400 also includes an analog joystick 410 that the user may manipulate to move a cursor or object on display 325. While IHS input device 400 is well suited as a game controller input device, input device 400 may be employed in any application where the user desires the location and spatial orientation of input device 400 in real space to affect the image viewed by a corresponding object moving in virtual space. Input device 400 includes an on-off switch 505 mounted on a housing 510. Display 325, digital pad 405 and analog joystick 410 also mount on housing as shown. IHS input device 400 includes an antenna 515 to facilitate communication with other devices and IHSs.

In one embodiment, input device 400 may be configured as a personal digital assistant (PDA) that provide a virtual view from a particular location to allow a user to effectively see at night, in fog, through water or from a higher elevation than the user's current location. In another application, input device 400 may provide orientation, tilt and/or location information as input to a gaming device.

FIG. 6 shows a flowchart that describes process flow of the application software 360 loaded into memory 315 to control the sensing of location information, the sensing of spatial orientation information and the rendering of an image corresponding to a view from the current location, and with the current spatial orientation, of input device 400. When the user changes the location and spatial orientation of input device 400 in real space, the image displayed on display 325 changes in virtual space in step with movement in real space. The location of input device 400 in the displayed virtual space is a direct function of the position coordinates, x, y and z, of input device 400 itself in real space. Moreover, the spatial orientation or view supplied to the display in virtual space is a direct function of the spatial orientation of input device 400 itself in real space. More particularly, as seen in the flowchart of FIG. 6, input device 400 senses its own current absolute location in terms of x, y and z coordinates, as per block 600. GPS location sensor 341 performs this location sensing in real time. Heading sensor 342 senses the current heading or yaw of input device 400 in real time, as per block 605. Tilt sensor 343 senses the current pitch of input device 400 in real time, as per block 610. Moreover, in one embodiment, tilt sensor 343 senses the roll of input device 400 in real time, as per block 615. Input device 400, or alternatively server 115, determines a view vector by combining the current absolute location information with the current spatial orientation information such as pitch and yaw, as per block 620. Input device 400 or server 115 generates a two dimensional (2D) image of three dimensional (3D) virtual space from the view vector and the current location information. Input device 400 or server 115 may include a rendering engine (not shown) that receives the view vector, receives the current location information, and generates the 2D image therefrom, as per block 625. Input device 400 displays the resultant 2D virtual space image as per block 630. The displayed virtual space image is from the perspective of the input device in virtual space. Process flow then continues back to again sense the current absolute location at block 600 and input device 400 repeats the process described above. In this manner, input device 400 continuously updates the virtual space image that it displays to the user.

Those skilled in the art will appreciate that the methodology disclosed, such as seen in the flow chart of FIG. 6 can be implemented in hardware or software. Moreover, the disclosed methodology may be embodied in a computer program product, such as a media disk, media drive or other storage media, or may be divided among multiple computer program products.

In one embodiment, the disclosed methodology is implemented as an application 360, namely a set of instructions (program code) in code modules which may, for example, be resident in the system memory 315 of system 400 of FIG. 4. Until required by system 400, the set of instructions or program code may be stored in another memory, for example, non-volatile storage 330 such as a hard disk drive, or in a removable memory such as an optical disk or floppy disk, or downloaded via the Internet or other computer network. Thus, the disclosed methodology may be implemented in a computer program product for use in a computer or information handling system such as system 400. It is noted that in such a software embodiment, code which carries out the functions described in the flowchart of FIG. 6 may be stored in RAM or system memory 315 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The foregoing discloses a method and apparatus that, in one embodiment, determines a virtual position, virtual orientation and virtual velocity as a direct function of the real position coordinates, orientation and velocity of the input device itself. One embodiment of the input device enables a user to move the input device in real time and space to affect the desired virtual movement independent of the user's hand position on the input device. This allows the user to move the input device in a fashion that can provide an alternative and independent perspective that is not generally achievable with some input devices such as a glove type input device, for example. In one embodiment, the disclosed input device is more intuitive than a joystick or other type of actuated controller. For example, a user can move the input device in real space to a position which corresponds to a space below a chair in virtual space displayed on the input devices display. This creates a “bug's eye view” of a chair leg, a position which is very awkward for a virtual glove and cognitively challenging with a joystick actuator. In one embodiment, the input device itself maps its own motions in 3D real space to 3D virtual space that displays on the input device's own on-board display.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of operating an input device to provide position information that includes location information and spatial orientation information of the input device, the method comprising:
determining, by a location sensor in the input device, the location of the input device in real space, thus providing the location information;
determining, by a spatial orientation sensor in the input device, the spatial orientation of the input device in real space, thus providing the spatial orientation information; and
processing, by a processor, the location information and the spatial orientation information of the input device in real space to determine an image view from the perspective of the input device in virtual space.

2. The method of claim 1, wherein the determining the location step further comprises determining the location of the input device in one of an xy plane and an xyz coordinate system.

3. The method of claim 1 further comprising displaying, by a display in the input device, the image view.

4. The method of claim 1 further comprising displaying, by an information handling system external to the input device, the image view.

5. The method of claim 1 further comprising offloading, by the processor, at least a portion of the processing step to an information handling system coupled to the input device.

6. The method of claim 1, wherein the determining the location step is performed by a global positioning system type location sensor.

7. The method of claim 1, wherein the determining the spatial orientation step is performed by a tilt sensor type spatial orientation sensor.

8. The method of claim 1, wherein the determining the spatial orientation step determines the pitch, roll and yaw of the input device.

9. An input device for providing position information including location information and spatial orientation information of the input device, the input device comprising:
a location sensor that determines the location of the input device in real space to provide the location information;
a spatial orientation sensor that determines the spatial orientation of the input device in real space to provide the spatial orientation information; and
a processor, coupled to the location sensor and the spatial orientation sensor, that processes the location information and the spatial orientation information of the input device in real space to determine an image view from the perspective of the input device in a virtual space.

10. The input device of claim 9, wherein the location information includes the real time location of the input device in one of an xy plane and an xyz coordinate system.

11. The input device of claim 9, further comprising a display, coupled to the processor, that displays the image view from the perspective of the input device in a virtual space.

12. The input device of claim 9, wherein the input device couples to an information handling system (IHS) external to the input device, the IHS including a display that displays the image view.

13. The input device of claim 9, wherein the input device couples to an information handling system (IHS) external to the input device such that at least a portion of the processing of the location information and spatial orientation information is offloaded to the IHS external to the input device.

14. The input device of claim 9, wherein the location sensor comprises a global positioning system type location sensor.

15. The input device of claim 9, wherein the spatial orientation sensor comprises at least one of a digital compass and a tilt sensor.

16. The input device of claim 9, wherein the spatial orientation sensor determines the pitch, roll and yaw of the input device.

17. A computer program product stored on a computer operable medium for processing position information including location information and spatial orientation information of an input device, the computer program product comprising:
instructions for determining the absolute location of the input device in real space, thus providing the location information;
instructions for determining the spatial orientation of the input device in real space, thus providing the spatial orientation information; and
instructions for processing the location information and the spatial orientation information of the input device in real space to determine an image view from the perspective of the input device in virtual space.

18. The computer program product of claim 17, wherein the location information includes the real time location of the input device in one of an xy plane and an xyz coordinate system.

19. The computer program product of claim 17, further comprising instructions for displaying the image view from the perspective of the input device in a virtual space.

20. The computer program product of claim 17, wherein the spatial orientation information includes at least one of yaw, pitch and roll information.
